(19) United States
(12) Patent Application Publication
(10) Pub. No.: US 2014/0082507 A1
(43) Pub. Date: Mar. 20, 2014

(54) INTERACTIVE MULTI-SCREEN SERVICE CONTENT DELIVERY METHOD AND DEVICE

(71) Applicants: Nan Wang, Shanghai (CN); Zhikun Wan, Shanghai (CN)

(72) Inventors: Nan Wang, Shanghai (CN); Zhikun Wan, Shanghai (CN)

(73) Assignee: Alcatel Lucent, Paris (FR)

(21) Appl. No.: 14/117,722

(22) PCT Filed: Apr. 25, 2012
(86) PCT No.: PCT/IB2012/000989

§ 371 Date: Nov. 14, 2013

(30) Foreign Application Priority Data
May 19, 2011 (CN) 201110130607.8

(51) Int. Cl. H04L 12/24

(52) U.S. Cl. CPC H04L 41/509
USPC 715/738

(57) ABSTRACT

The present invention relates to a method for delivering interactive multi-screen service content in a multi-screen service content delivery system as well as a server and user terminal for implementing the method. According to an embodiment of the present invention, a method of delivering multi-screen content from a server to a plurality of user terminals simultaneously in a multi-screen content delivery system comprises: providing an interactive media document form the server to the plurality of user terminals wherein the interactive media document comprises an identification of the multi-screen content and a plurality of time options for playing or downloading the multi-screen content and the server collecting a plurality of user-selected time options and multicasting or broadcasting the multi-screen content according to the selected time options such that broadcast/multicast technique is used as much as possible for simultaneous video content delivery to a plurality of user to improve the efficiency of network utilization.

### FIELD OF THE INVENTION

The present invention relates to a multi-screen service content delivery system, and specifically to a method for delivering interactive multi-screen service content in the multi-screen service content delivery system as well as a server and user terminal for implementing the method.

### BACKGROUND OF THE INVENTION

A plurality of indicators are foretelling that multi-screen (Mobile-phone, PC and TV) content delivery will become the next broadband service mega-trend for telecom operators and service providers.

However, online playing of HD (high-definition) video content is a great challenge, and the bandwidth of the related delivery network, such as Cellular Network, Internet, IP Network, is still the bottleneck of the multi-screen content delivery system. Especially, it will cause serious network congestion when a large number of multi-screen users require huge multi-screen video content document (e.g., multimedia movie) delivery simultaneously.

The inventor thinks there are two aspects to deal with the above challenge: Firstly, broadcast and multicast, e.g., IP multicast in IPTV network and MBMS (Multimedia Broadcast and Multicast) in 3G cellular communication network, have much higher efficiency to utilize network bandwidth than unicast. Therefore, to use broadcast and multicast as more as possible, a mechanism can be designed to encourage users to watch their multi-screen content at some fixed starting time (for example, starting at 18:00, 19:00, 20:00, 21:00).

Secondly, during some period of each day, e.g., 1:00 AM to 6:00 AM, the network is relatively idle. Thus, if multi-screen content (typically, one movie for example) can be transmitted during the above idle time, it will bring a minimum load to the multi-screen delivery network and bandwidth resources can be utilized with the highest efficiency. In fact, some users do not mind when they can receive the multi-screen content. Therefore, a mechanism can be designed to encourage download-type users to download their multi-screen content at the idle time.

Currently, there is short of a method to let multi-screen users to actively cooperate with and comply with the multi-screen service provider's content playing schedule, and there is not any encouragement mechanism to multi-screen users, that is, users who actively download multi-screen content at the idle time cannot get any real benefit. At the same time, one existing method to interact with a multi-screen user is to send and receive short messages SMS. However, there is short of a uniform SMS format to reflect the multi-screen user's feedback. More importantly, the latency of SMS is rather long, and the latency varies frequently. Therefore, the server cannot respond to the user's SMS commands in time and the feelings of the user to interact with the server are also poor.

### SUMMARY OF THE INVENTION

The present invention provides a multi-screen content delivery system based on OMA (Open Mobile Alliance) interactivity mechanism and user feedback. The purpose of this invention is to establish an interactive mechanism to encourage and induce users to actively cooperate with or comply with telecom operator's or multi-screen service provider's content playing schedule. Thus, the bandwidth bottleneck of the multi-screen service can be improved greatly.

On the one hand, the present invention provides a method of delivering multi-screen content from a server to a plurality of user terminals in a multi-screen content delivery system simultaneously, the method comprising: providing an interactive media document from the server to the plurality of user terminals, wherein the interactive media document comprises an identification of multi-screen content and a plurality of time options for playing or downloading the multi-screen content; and the server collecting a plurality of user-selected time options and multicasting or broadcasting the multi-screen content according to the selected time options.

Furthermore, the present invention provides a server in a multi-screen content delivery system, the server comprising: means for providing an interactive media document to a plurality of user terminals, wherein the interactive media document comprises an identification of multi-screen content and a plurality of time options for playing or downloading the multi-screen content; and means for collecting a plurality of user-selected time options and multicasting or broadcasting the multi-screen content according to the selected time options.

On the other hand, the present invention provides a method of delivering interactive information from a user terminal in a multi-screen content delivery system to a server, the method comprising: the user terminal receiving an interactive media document from the server, wherein the interactive media document comprises an identification of multi-screen content and a plurality of time options for playing or downloading the multi-screen content; and the user terminal selecting one time option from the plurality of time options and providing it to the server such that the server multicasts or broadcasts the multi-screen content according to the selected time option.

The invention further relates to a user terminal in a multi-screen content delivery system, the user terminal comprising: means for receiving an interactive media document from a server of the multi-screen content delivery system, wherein the interactive media document comprises an identification of multi-screen content and a plurality of time options for playing or downloading the multi-screen content; and means for selecting one time option from the plurality of time options and providing it to the server such that the server multicasts or broadcasts the multi-screen content according to the selected time option.

Of course, each multi-screen service user may also send his or her own desired video content playing time to a multi-screen service provider that may add the number of times of the video content being played besides original options according to the collected user-desired video playing time, select the playing start time according to the time most users want, plan a uniform playing time, and notify users of the newly added playing time in advance. According to an embodiment of the present invention, the plurality of time options comprise at least one time option in an idle period of the multi-screen content delivery system.

According to an embodiment of the present invention, different charging criteria are set for different time options, wherein fewer fees are charged for time options in an idle period of the multi-screen content delivery system than for time options in a busy period of the multi-screen content delivery system.

According to an embodiment of the present invention, the interactive media document further comprises a plurality of terminal types for playing or downloading the multi-screen content.

According to an embodiment of the present invention, the interactive media document comprises one of the following: OMA protocol timetable template, SIP protocol timetable template, SMS timetable template and corresponding multi-screen service Website/WAP site or Web link/WAP link.

On the one hand, to Video content on Demand (VoD)-type users, this multi-screen content delivery system encourages the VoD-type users to watch their multi-screen content in some fixed time periods (for example, begin at 18:00, 19:00, 20:00, 21:00). Thus, the service provider can use multicast or broadcast technique to deliver the corresponding multi-screen content in the above fixed time periods (for example, begin at 18:00, 19:00, 20:00, 21:00). In practical use, a lower price and a higher score can be given to these VoD users. Of course, this new system also supports the option that allows a user to play her/his preferred movie immediately. In this case, the price is the highest and the score is the lowest.

On the other hand, to download-type users, this new multi-screen content delivery system encourages the download-type users to automatically perform download operation at idle time of the multi-screen content delivery system (for example, 1:00 AM-6:00 AM). Thus the service provider can push the corresponding multi-screen video content to the corresponding terminals of the users at the above-mentioned idle time (for example, 1:00 AM-6:00 AM). The service providers can even select the idlest moment of the network during 1:00 AM-6:00 AM and use multicast technique to push video content simultaneously to users who want to download the same video content, and it is clear at this time that the network utilization is the most efficient and most beneficial to the operator and the service provider. In this case, the price is very low while the score is very high to attract and encourage users to actively cooperate in the demand time; of course, this new system also supports the option that allows a user to download her/his preferred movie immediately. In this case, the price is the highest and the score is the lowest.

In practice, a concrete encouragement measure may be discount of fee or internal score (for example, accumulative 1000 score can download a free movie) for a multi-screen user. Of course, the service provider can also imagine other encouragement measures, which however does not belong to the scope of the present invention discussed.

As compared to existing multi-screen service content delivery mechanism, the present invention brings the following advantages:

Firstly, the present invention proposes a totally new method to encourage and induce users to comply with a service provider's schedule actively. It is well known to those skilled in the art that some high-definition movies usually have 3GB or bigger size. Thus, if each multi-screen user performs online playing or downloading at random time, the network and the multi-screen server will degrade into congestion and even collapse. Using the method of the present invention, as many as possible multi-screen users can actively accept (at those predefined time points) broadcast/multicast delivery method and more users will download multi-screen content such as movie at the network idle time. Thus, this method has the highest efficiency of bandwidth utilization and the smallest congestion danger.

Secondly, the present invention provides one set of uniform command and message format (OMA compatible) or uniform Web page/WAP page to collect and respond to playing/downloading time requirements of multi-screen users. Using this new notification and interaction mechanism, the operator or service provider can effectively collect and respond to the playing/downloading time requirements of all multi-screen users. Broadcast/multicast technique is used as much as possible for simultaneous video content delivery to a plurality of users to improve the efficiency of network utilization.

Thirdly, using this method, the service provider for multi-screen service can setup a set of flexible price policy and content schedule mechanism to improve the service provider's competition power. On the one hand, this new system supports the option that allows a user to download or play his/her preferred movie immediately. In this case, the price is the highest and the internal score is the lowest. On the other hand, if the user would comply with the multi-screen service provider's schedule (for example, to watch the multi-screen content at a predefined time point), and in this case, the price is very low and the user can get a higher score.

### BRIEF DESCRIPTION OF THE DRAWINGS

An exemplary embodiment of the present invention will be described below with reference to the drawings. In the drawings, the same or similar technical features are denoted by the same reference signs.

FIG. 1 shows a schematic diagram of an interactive media document according to the invention;

FIG. 2 is a schematic diagram of Web page/WAP page to collect user feedback in the embodiment of the present invention; and

FIG. 3 is a method flow chart for implementing the embodiment of the present invention.

### DETAILED DESCRIPTION OF THE INVENTION

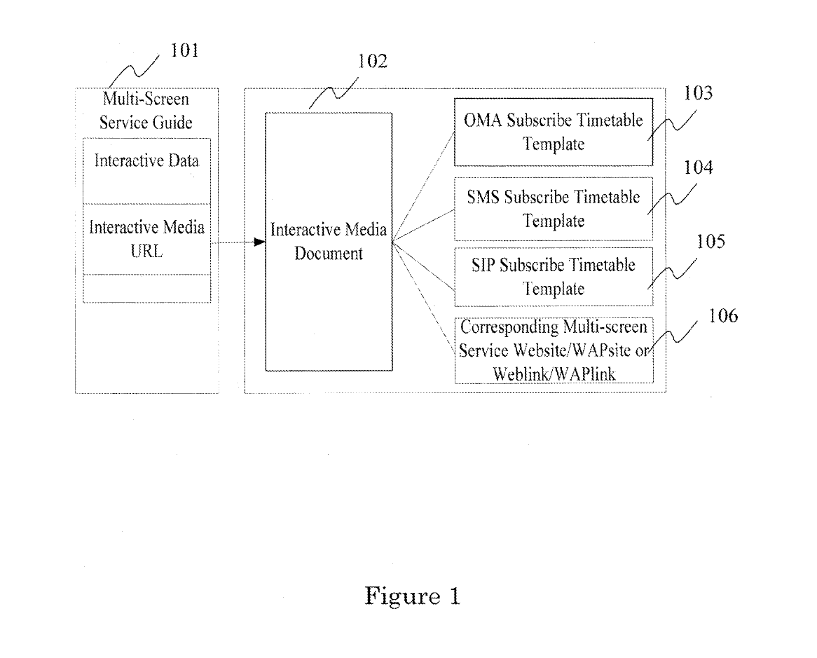

FIG. 1 is a schematic diagram of an interactive media document according to the invention. To notify all users, a multi-screen service provider uses a broadcast or multicast mechanism to send one multi-screen guide, which includes one OMA interactive media document, to each multi-screen user. According to a preferred embodiment of the present invention, in FIG. 1, multi-screen service guide 101 comprises interactive media document 102 as part of interactive data. The OMA interactive media document also includes all of encouragement measures, score policy and content playing schedule information of corresponding multi-screen video (timetable). Moreover, all of the encouragement measures, score policy and content schedule information of corresponding multi-screen video (timetable) will be shown on the multi-screen service website, and multi-screen users can know related information by using their PCs. Furthermore, via the IPTV portal, multi-screen users can also know related information by using their IPTV STBs (set-top boxes) and TV remote controllers.

This OMA interactive media document also includes a specific OMA/SIP/SMS timetable template and can also include a link of corresponding multi-screen content Webpage/WAP page, i.e., OMA protocol timetable template 103, SIP protocol timetable template 104, SMS protocol timetable template 105 and corresponding multi-screen service Web site/WAP site or Web link/WAP link 106 shown in FIG. 1.

Thus, no matter a user uses an OMA interactive media document or SIP/SMS commands or web link, he/she can easily feedback his/her playing-time or downloading-time to the interactive server of the multi-screen content delivery system. For example, the preferred playing or downloading time (pre-defined time options) will be filled by the user into the timetable template.

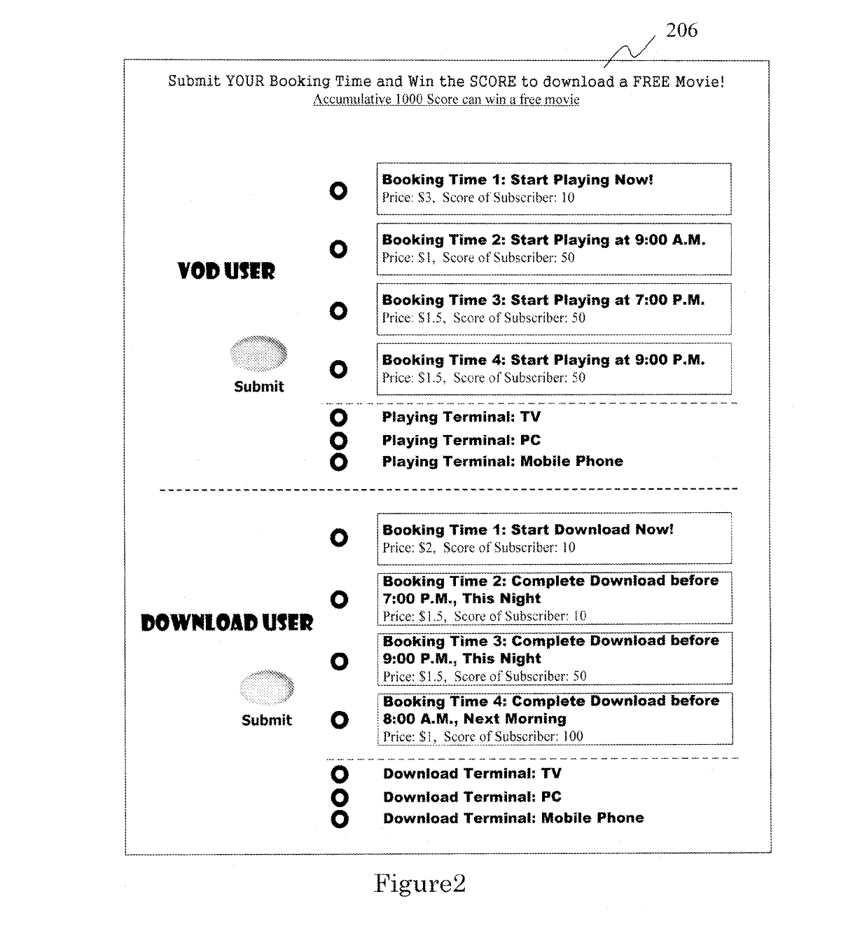

FIG. 2 is a schematic diagram of Web page/WAP page to collect user feedback in the embodiment of the present invention. Once multi-screen users login in a multi-screen service website by using their PCs, a VoD-type multi-screen user can select and submit his/her preferred content playing time from some predefined time options (for example, 18:00, 19:00, 20:00, 21:00). Moreover, a download-type multi-screen user can submit his/her deadline that the multi-screen content is downloaded completely. Thus, the service provider can utilize the idle time to deliver the corresponding multi-screen content before the deadline. Typically, the downloading is automatically performed during 1:00 AM-6:00 AM. Of course, the user can select the preferred playing/downloading terminal, which will be used to watch or download the movie, and submit simultaneously on the same Web page/WAP page the selected playing/downloading terminal.

Furthermore, in the embodiment of the present invention, assuming the multi-screen users login in the multi-screen service IPTV portal by using their IPTV STBs (set-top boxes) and TV remote controllers, a VoD-type multi-screen user can select and submit his/her preferred content playing time from some predefined time options (for example, 18:00, 19:00, 20:00, 21:00). Moreover, a download-type multi-screen user can submit his/her deadline that the multi-screen content is downloaded completely. Thus, the service provider can utilize the idle time to deliver the corresponding multi-screen content before the deadline. Typically, the downloading is automatically performed during 1:00 AM-6:00 AM. Of course, the user can select the preferred playing/downloading terminal, which will be used to watch or download the movie, and submit simultaneously on the same Web page/WAP page the selected playing/downloading terminal.

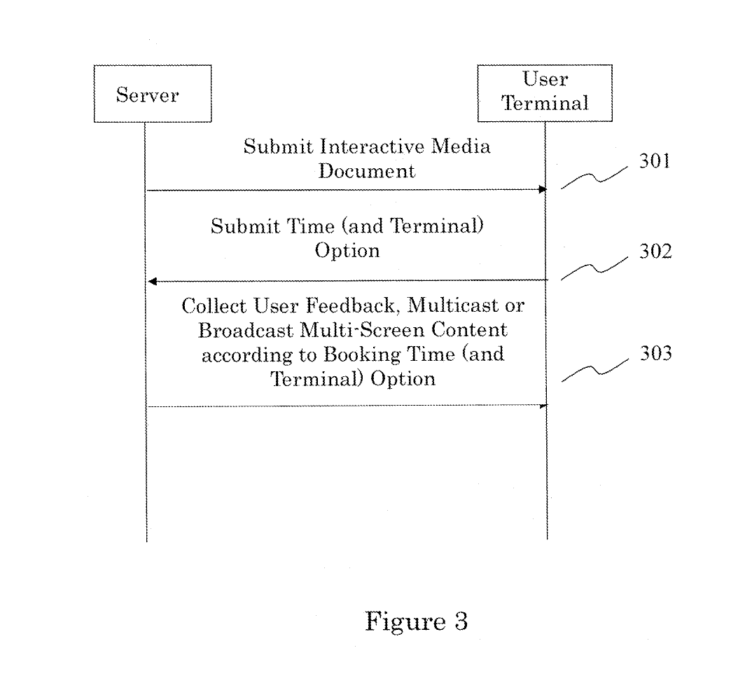

FIG. 3 is a method flow chart for implementing the embodiment of the present invention.

According to the embodiment of the present invention, the interactive server in the multi-screen content delivery system provides a multi-screen service guide to the multi-screen user terminal, as shown in step 301. The multi-screen service guide can comprise, for example, OMA interactive media document that also comprises specific OMA/SIP/SMS timetable templates and can also comprise links of corresponding multi-screen content Web page/WAP page, such as OMA protocol timetable template 103, SIP protocol timetable template 104, SMS schedule template 105 and corresponding multi-screen service Web site/WAP site or Web link/WAP link 106 shown in FIG. 1.

In step 302, the multi-screen user selects his/her own preferred option according to the timetable provided by the interactive media document and the terminal option and submits the corresponding option. By example of Web page/WAP page to collect user feedback as shown in FIG. 2, to a VoD user, for example “Booking Time 4: Start Playing at 9:00 P.M.” may be selected, and the on-demand price in this case may be for example $1 each time while the user score may be 50. As a backup option, the interactive media document can also select the playing terminal, and the VoD user can select any one of TV, PC and mobile phone as the booking playing terminal. For example, the VoD user can select the PC as the playing terminal.

In step 303, the interactive server collects the user option and delivers the multi-screen content to the multi-screen user according to the booking time and the terminal option. If a plurality of users have booked to play the same movie at 21:00, then the interactive server will deliver the on-demand multi-screen content to the plurality of users by using multicast or even broadcast according to the above booking time, i.e., at 21:00. Of course, according to playing terminal requirements of different users, the corresponding content is played to the playing terminal set by the respective user.

By example of Web page/WAP page to collect user feedback as shown in FIG. 2, to a download-type user, for example “Booking Time 4: Complete Download before 8:00 A.M., Next Morning” may be selected. To encourage the user to download the required multi-screen content at the network idle time, the on-demand price in this case may be for example $1 while the user score may be 100. As a backup option, the interactive media document can also select the downloading terminal, and the VoD user can select any one of TV, PC and mobile phone as the booking downloading terminal.

In step 303, the interactive server collects the user option and delivers the multi-screen content to the multi-screen user according to the booking downloading time and the terminal option. If a plurality of users have booked to complete downloading of the same multi-screen content before 8:00 A.M. next morning, then the interactive server will push the user-required multi-screen content to the plurality of users according to the above booking time, i.e., before 8:00 A.M. next morning. Of course, according to playing terminal requirements of different users, the corresponding content is downloaded to the downloading terminal set by the respective user.

In the present invention, the interactive server and the user terminal can be implemented through a combination of hardware and software.

According to the embodiment of the present invention, the interactive server comprises means for providing an interactive media document to a plurality of user terminals, and means for collecting a plurality of user-selected time options and multicasting or broadcasting the multi-screen content according to the selected options, wherein the interactive media document comprises an identification of multi-screen content and a plurality of time options for playing or downloading the multi-screen content.

According to the embodiment of the present invention, the user terminal includes means for receiving an interactive media document from the server in the multi-screen content delivery system, and means for selecting one time option from the plurality of time options and providing it to the server such that the server multicasts or broadcasts the multi-screen content according to the selected time option, wherein the interactive media document includes an identification of multi-screen content and a plurality of time options for playing or downloading the multi-screen content. The means mentioned above can be implemented by computer software modules, and it is not particularly difficult for those skilled in the art to implement these means.

It is obvious that by providing a selectable interactive media document to multi-screen users and collecting user feedback, the interactive server can provide on-demand or downloaded multi-screen content to multi-screen users by using multicast or broadcast technique. Preferably, the service provider can encourage multi-screen users to watch or download the desired multi-screen content at the network idle time by using the price lever in order to effectively solve the bandwidth bottleneck of the multi-screen delivery system and improve network utilization.

In practical applications, the multi-screen service provider can develop corresponding encouragement measures based on the interactive content delivery mechanism of the present invention, such as discount of fee or internal score for multi-screen user (for example, accumulative 1,000 score can download a free movie), to encourage the VoD-type users to watch their multi-screen content at a fixed time and to encourage the download-type users to download their desired multi-screen content at the idle time. Thus, the bandwidth bottleneck of the multi-screen service can be improved greatly. Those skilled in the art should understand that the above description with reference to the drawings is illustrative, rather than to limit the scope of the invention. Those skilled in the art may devise various modifications and variations within the spirit and scope of the invention defined by the appended claims.

1. A method of delivering multi-screen content from a server to a plurality of user terminals simultaneously in a multi-screen content delivery system, comprising:
providing an interactive media document from the server to the plurality of user terminals, wherein the interactive media document comprises an identification of multi-screen content and a plurality of time options for playing or downloading the multi-screen content; and
the server collecting a plurality of user-selected time options and multicasting or broadcasting the multi-screen content according to the selected time options.

2. The method of claim 1, wherein the plurality of time options comprise at least one time option in an idle period of the multi-screen content delivery system.

3. The method of claim 2, further comprising setting different charging criteria for different time options, wherein fewer fees are charged for time options in an idle period of the multi-screen content delivery system than for time options in a busy period of the multi-screen content delivery system.

4. The method of claim 1, wherein the interactive media document further comprises a plurality of terminal types for playing or downloading the multi-screen content.

5. The method of claim 1, wherein the interactive media document comprises one of the following: OMA protocol timetable template, SIP protocol timetable template, SMS timetable template and corresponding multi-screen service Website/WAP site or Web link/WAP link.

6. A server in a multi-screen content delivery system, comprising:
means for providing an interactive media document to a plurality of user terminals, wherein the interactive media document comprises an identification of multi-screen content and a plurality of time options for playing or downloading the multi-screen content; and
means for collecting a plurality of user-selected time options and multicasting or broadcasting the multi-screen content according to the selected time options.

7. The server of claim 6, further comprising means for setting different charging criteria for different time options, wherein fewer fees are charged for time options in an idle period of the multi-screen content delivery system than for time options in a busy period of the multi-screen content delivery system.

8. A method of delivering interactive information from a user terminal in a multi-screen content delivery system to a server, the method comprising:
the user terminal receiving an interactive media document from the server, wherein the interactive media document comprises an identification of multi-screen content and a plurality of time options for playing or downloading the multi-screen content; and
the user terminal selecting one time option from the plurality of time options and providing it to the server such that the server multicasts or broadcasts the multi-screen content according to the selected time option.

9. The method of claim 8, wherein the plurality of time options comprise at least one time option in an idle period of the multi-screen content delivery system.

10. The method of claim 8, wherein the interactive media document further comprises a plurality of terminal types for playing or downloading the multi-screen content.

11. The method of claim 8, wherein the interactive media document comprises one of the following: OMA protocol timetable template, SIP protocol timetable template, SMS timetable template and corresponding multi-screen service Website/WAP site or Web link/WAP link.

12. A user terminal in a multi-screen content delivery system, comprising:
means for receiving an interactive media document from a server of the multi-screen content delivery system, wherein the interactive media document comprises an identification of multi-screen content and a plurality of time options for playing or downloading the multi-screen content; and
means for selecting one time option from the plurality of time options and providing it to the server such that the server multicasts or broadcasts the multi-screen content according to the selected time option.
